(19) United States
(12) Patent Application Publication
(10) Pub. No.: US 2025/0059918 A1
(43) Pub. Date: Feb. 20, 2025

(54) AIRCRAFT TURBOMACHINE COMPRISING A DEVICE FOR INHIBITING THE ACCUMULATION OF COKE IN A DUCT

(71) Applicant: SAFRAN HELICOPTER ENGINES, Bordes (FR)

(72) Inventors: Benjamin Nicolas FULLERINGER, MOISSY-CRAMAYEL (FR); Alexandre DEBAT, MOISSY-CRAMAYEL (FR); Pierre-Marie FONTS, MOISSY-CRAMAYEL (FR); Olivier ROBERT, MOISSY-CRAMAYEL (FR)

(73) Assignee: SAFRAN HELICOPTER ENGINES, Bordes (FR)

(21) Appl. No.: 18/721,492

(22) PCT Filed: Dec. 21, 2022
(86) PCT No.: PCT/FR2022/052466

§ 371 Date: Jun. 18, 2024

(30) Foreign Application Priority Data
Dec. 24, 2021 (FR) FR2114477

(51) Int. Cl. F02C 7/30; F02C 3/04; F23R 3/28

(52) U.S. Cl. CPC F02C 7/30; F02C 3/04; F23R 3/28

(57) ABSTRACT

An aircraft turbomachine has a gas generator that includes, along a longitudinal axis (X), at least one compressor, a combustion chamber, and at least one turbine. The turbomachine further includes at least one duct for supplying liquid to at least one member chosen from an oil jet and a fuel injector. The duct (20) has rectilinear portions and bent portions and includes at least one region in which the liquid is liable to coke. The turbomachine also includes at least one turbulence element in the at least one region in the duct.

### DESCRIPTION

### Technical Field of the Invention

The present invention relates to the general field of aeronautic. More specifically, it is aimed at an aircraft turbomachine.

### Technical Background

The technical background comprises in particular the documents U.S. Pat. No. 9,644,495B2, EP-A2-0 822 345 and EP-A1-2 900 974.

Conventionally, an aircraft turbomachine comprises a gas generator comprising along a longitudinal axis at least one compressor, a combustion chamber, and at least one turbine.

An air flow enters the gas generator and is compressed in the compressor or the compressors. This compressed air flow is mixed with fuel and burned in the combustion chamber and the combustion gases are expanded in the turbine or the turbines. This expansion causes the rotation of the turbine rotor(s), which in turn causes the rotation of the compressor rotor(s). The combustion gases are ejected through a jet to provide thrust, which can be added to the thrust provided by at least one propulsion propeller of the turbomachine.

To operate, the turbomachine needs liquids such as fuel to feed the combustion chamber, and oil to lubricate mechanical components such as the guide bearings of the rotors. To achieve this, the turbomachine includes liquid supply ducts. In particular, the turbomachine comprises one or more oil supply ducts for oil nozzles on bearings, for example. The turbomachine also comprises one or more fuel supply ducts for fuel injectors in the combustion chamber.

During operation or when the engine is stopped, the turbomachine can reach high temperatures, and the oil and fuel can reach relatively high temperatures.

These high temperatures are likely to encourage the generation of cokes in the ducts. In this application, “coke” means a solid mass resulting from the deposition and accumulation of oil or fuel residues, linked to the thermal degradation of this liquid. This phenomenon is called coking and can eventually lead to partial or total blockage of the duct.

When coke deposits lead to a significant reduction in the flow rate of oil injected into the bearings, for example, rapid and severe bearing failure can occur (seizure of the bearing), with major damage to the turbomachine. So, coking the bearing oil supply duct in the hot area is a major safety and reliability issue. It is therefore important to avoid or limit this phenomenon, or to find a solution to eliminate the coke that may form in the ducts.

One solution is to thermally protect the ducts to limit heating of the liquid by thermal radiation from hot parts of the engine (see for example FR-A1-3 041 700). Another solution is to ventilate the ducts to limit heating of the liquid. However, these solutions are relatively complex and costly to implement, and are therefore not entirely satisfactory. What's more, these solutions involve tackling the problem from the thermal side, which is the source of the problem. However, the engine stop phase remains problematic, as there is no longer any flow of oil or air to evacuate the heat stored by the hot parts of the engine. The present invention offers a simple, effective and economical solution to this need.

### SUMMARY OF THE INVENTION

The present invention proposes an aircraft turbomachine, comprising a gas generator comprising, along a longitudinal axis, at least one compressor, a combustion chamber and at least one turbine, the turbomachine further comprising at least one duct for supplying liquid to at least one member chosen from an oil nozzle and a fuel injector, this duct comprising rectilinear portions and bent portions and comprising at least one area in which the liquid is liable 30 to coke, characterized in that it comprises at least one turbulence element projecting at the level of said at least one area in the duct.

The present invention therefore proposes equipping the duct with one or more internal turbulence elements so that these elements generate turbulences in the flow of the liquid which will clean the duct by removing any coke deposits. The turbulence elements are therefore preferably positioned in the areas where coke is liable to form. The turbulence elements enable the duct to be self-cleaning, which is advantageous compared to solutions in previous technology.

The turbomachine may comprise one or more of the following characteristics, taken alone or in combination with each other:
the duct comprises several successive areas in which the liquid is liable to coke, at least one turbulence element being located at each of these areas in the duct.
the turbulence elements are of the same type;
the turbulence elements are of different types;
said or each turbulence element is an obstacle or a guide in the form of a stud, fin, helix, thread or twisted strip;
said or each turbulence element passes through all or part of the duct;
the duct supplies oil to a nozzle which is configured to lubricate at least one bearing of the turbomachine; and
the duct supplies fuel to a fuel injector in the combustion chamber.

The present invention also relates to a method of decoking a liquid supply duct, intended for implementation in a turbomachine according to the invention, comprising:
a first operating phase of the gas generator wherein liquid is conveyed by the duct to at least one member selected from an oil nozzle and a fuel injector, in order to supply it with this liquid,
a second stop phase of the gas generator wherein coke is liable to form in said at least one area of the duct,
a third restarting phase of the gas generator wherein liquid is conveyed through the duct to said member, said at least one turbulence element generating turbulences in the liquid which are configured to lift and evacuate the coke from said at least one area.

The method according to the invention is particularly advantageous in that it enables coke deposits in the duct to be removed automatically at each stop-start cycle without human intervention or any specific method. It is during the restart and engine operation phases of the following cycle that the element(s) generate(s) turbulences, allowing the duct to be cleaned by flushing out and removing any slight coke deposits. Unlike previous technology, the succession of such stop-start cycles will not lead to a progressive build-up of coke.

### BRIEF DESCRIPTION OF THE FIGURES

Further characteristics and advantages of the invention will become apparent from the following detailed description, for the understanding of which reference is made to the attached drawings in which:

FIG. 1 is a schematic axial sectional view of an aircraft turbomachine;

FIG. 2 is a larger-scale, more detailed schematic view of part of the turbomachine shown in FIG. 1;

FIG. 3 is a schematic perspective view of part of a liquid supply duct of the turbomachine of FIG. 1;

FIGS. 4a and 4b show very schematically examples of turbulence elements for a liquid supply duct;

FIGS. 4c and 4d show very schematically further examples of turbulence elements for a liquid supply duct; and

FIG. 4e show a very schematic representation of another example of a turbulence element for a liquid supply duct.

### DETAILED DESCRIPTION OF THE INVENTION

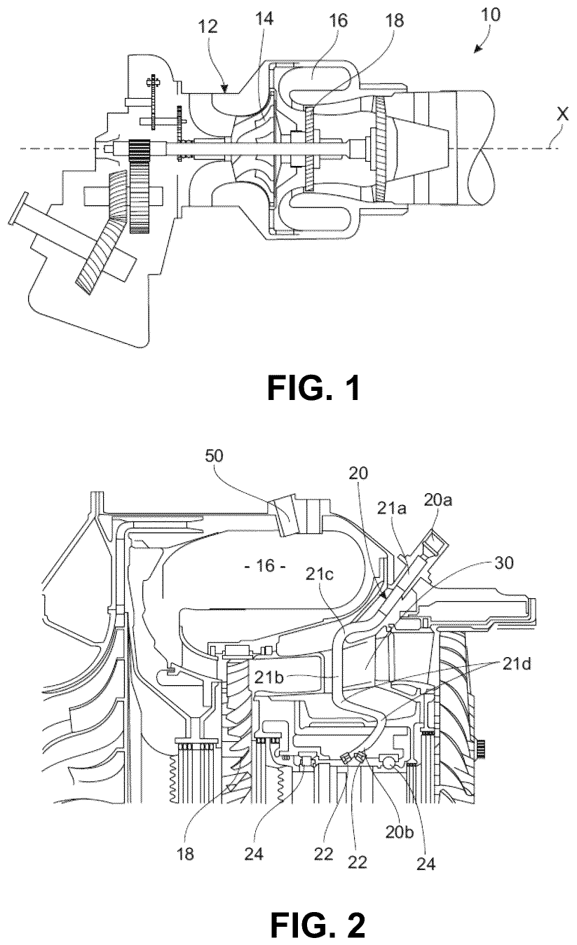

FIG. 1 shows a turbomachine 10 used in an aircraft, particularly a helicopter, although this application is not exhaustive.

The turbomachine 10 essentially comprises a gas generator 12 which comprises along a longitudinal axis X at least one compressor 14, a combustion chamber 16 and at least one turbine 18.

FIG. 2 shows in more detail the environment around the combustion chamber 16 and the turbine 18. FIG. 2 shows a liquid supply duct 20, and more particularly oil, to at least one oil nozzle 22.

The duct 20 has an upstream end 20a and a downstream end 20b with reference to the flow of oil in the duct 20. The upstream end 20a, on the left of the drawing, is connected to a source of oil, for example via a pump. The downstream end 20b is connected to at least one nozzle 22 which is configured to spray oil onto one or more guide bearings 24 of the turbine rotor(s).

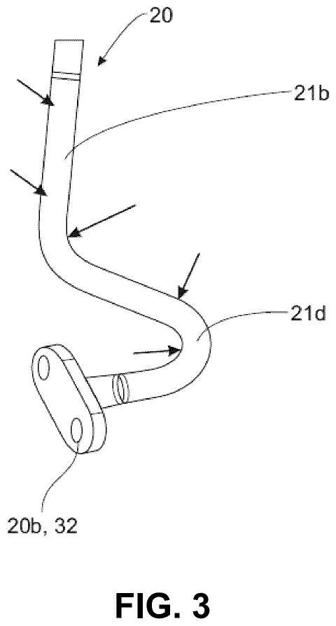

The duct 20 comprises rectilinear portions 21a, 21b and bent portions 21c, 21d. In the example shown, the duct 20 comprises:
a first rectilinear portion 21a which extends substantially radially downstream of the combustion chamber 16,
a right-angled bent portion 21c located at the downstream end of the rectilinear portion 21a,
a rectilinear portion 21b which extends radially with respect to the axis X from the bent portion 21c; this rectilinear portion 21a passes through a turbine stator vane 30 of the turbine 18 and therefore through the flow vein of the gas flow in the turbine, and
a U- or V-shaped bent portion 21d which is located radially inside the combustion chamber 16, and which connects the radially internal end of the rectilinear portion 21b to the nozzles 22, for example via a fixing flange 32 (see FIG. 3).

The duct 20 comprises at least one area in which the oil is liable to coking. FIG. 3 shows several successive areas of this type with arrows. The duct 20 can have areas distributed over its entire length from its upstream end to its downstream end.

According to the invention, the duct 20 comprises at least one turbulence element in the area or each of the areas of the duct.

The turbulence elements may be of the same type or of different types.

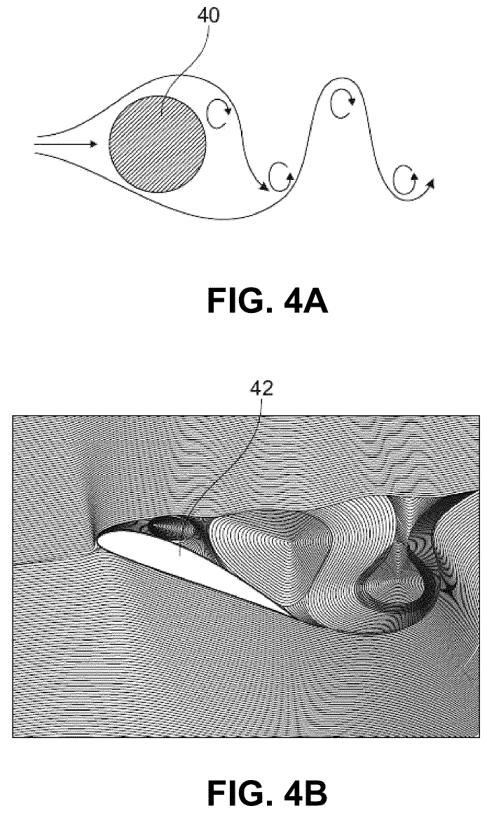

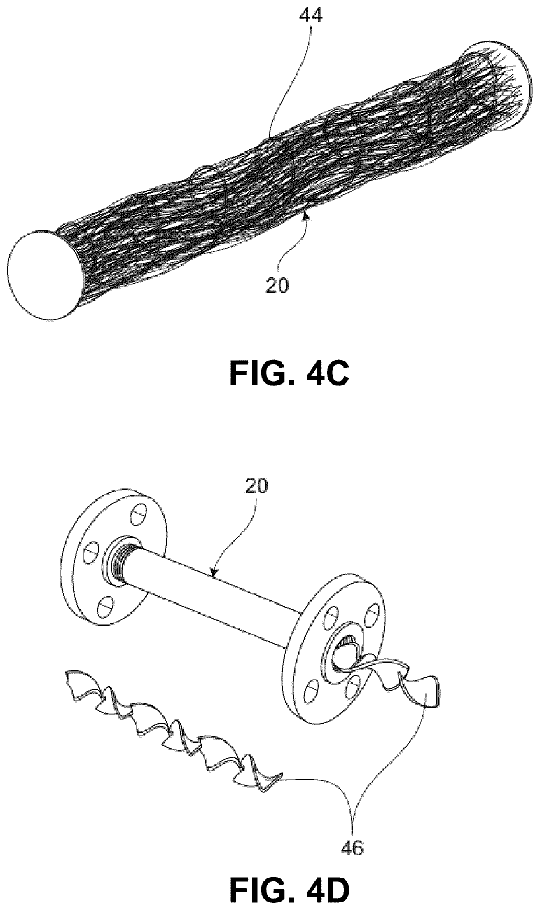

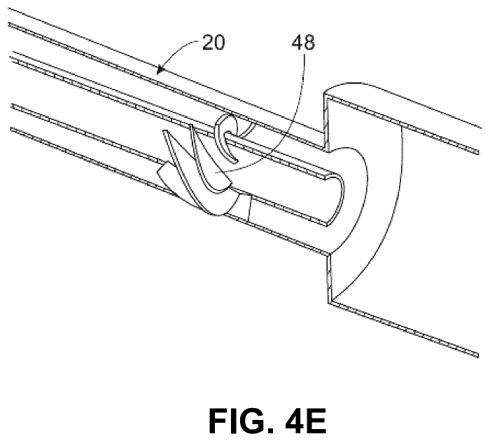

FIGS. 4a to 4e show several examples of the turbulence elements.

Each of these turbulence elements can be an obstacle (stud, fin, etc.) or a guide (propeller, thread, twisted strip, etc.).

FIG. 4a shows a turbulence element 40 in the form of a cylindrical stud. This stud protrudes from an internal surface of the duct 20 and generates turbulences in the oil flow.

FIG. 4b shows a turbulence element 42 in the form of fins or vanes. This element has an aerodynamic profile and projects from an internal surface of the duct 20 to generate turbulences in the form of wakes in the oil flow.

FIG. 4c shows a turbulence element 44 in the form of propellers or helical ribs or a helical thread, projecting from an internal surface of the duct 20 or engaged in the duct 20 to generate turbulences in the oil flow.

FIG. 4d shows a turbulence element 46 in the form of twisted strips which is engaged in the duct 20 to generate turbulences in the oil flow.

FIG. 4e shows a turbulence element 48 in the form of a propeller which is engaged or formed in the duct 20 to generate turbulences in the oil flow. The propeller comprises an annular row of fins, as in the case of a fan propeller for example. This propeller is fixed in the duct 20.

Although the duct 20 referred to above has been described in relation to an oil supply, the duct according to the invention could be used to supply fuel to a fuel injector 50 which equips the combustion chamber (see FIG. 2).

The present invention also relates to an automatic method of decoking the duct 20, which comprises:
a first operating phase of the gas generator 12 in which oil or fuel is conveyed by the duct 20 to the nozzle 22 or injector 50, in order to supply it,
a second stop phase of the gas generator 12 in which coke is liable to appear in at least one area of the duct 20,
a third restarting phase of the gas generator 12 in which liquid is conveyed through the duct 30 to the nozzle 22 or the injector 55, the turbulence element(s) then generating turbulences in the oil or fuel which are configured to lift and evacuate the coke from said or each area. The starting and the subsequent operating phase help to lift and evacuate the small quantity of coke generated in the previous stop phase alone.

1. An aircraft turbomachine, comprising a gas generator that includes, along a longitudinal axis (X), at least one compressor, a combustion chamber, and at least one turbine, the turbomachine further comprising at least one duct configured to supply liquid to at least one member chosen from an oil nozzle and a fuel injector, the duct having rectilinear portions and bent portions and comprising at least one area in which the liquid is liable to coke, the turbomachine further including at least one turbulence element projecting at a level of said at least one area in the duct.

2. The turbomachine according to claim 1, wherein the duct comprises several successive areas in which the liquid is liable to coke, at least one turbulence element being located at each of the successive areas in the duct.

3. The turbomachine according to claim 2, wherein the turbulence elements are of the same type.

4. The turbomachine according to claim 2, wherein the turbulence elements are of different types.

5. The turbomachine according to claim 1, wherein said or each turbulence element is an obstacle or a guide in the form of a stud, fin, propeller, thread, or twisted strip.

6. The turbomachine according to claim 1, wherein said or each turbulence element passes through all or part of the duct.

7. The turbomachine according to claim 1, wherein the duct supplies oil to a nozzle which is configured to lubricate at least one bearing of the turbomachine.

8. The turbomachine according to claim 1, wherein the duct supplies fuel to a fuel injector in the combustion chamber.

9. A method of decoking a liquid supply duct, for use in the turbomachine according to claim 1, the method comprising:
a first operating phase of the gas generator wherein the liquid is conveyed by the duct to at least one member selected from an oil nozzle and a fuel injector, in order to supply the at least one member with the liquid,
a second stop phase of the gas generator wherein the coke is liable to form in said at least one area of the duct, and
a third restarting phase of the gas generator wherein liquid is conveyed through the duct to said member, said at least one turbulence element generating turbulences in the liquid which are configured to lift and evacuate the coke from said at least one area.
